(19) United States
(12) Patent Application Publication
(10) Pub. No.: US 2024/0292498 A1
(43) Pub. Date: Aug. 29, 2024

(54) VEHICULAR GLASS MODULE

(71) Applicant: NIPPON SHEET GLASS COMPANY, LIMITED, Tokyo (JP)

(72) Inventors: Yota YANO, Tokyo (JP); Kazuhisa ONO, Tokyo (JP); Ryuichi TASHIRO, Tokyo (JP)

(21) Appl. No.: 18/572,834

(22) PCT Filed: Jun. 28, 2022
(86) PCT No.: PCT/JP2022/025737

§ 371 Date: Dec. 21, 2023

(30) Foreign Application Priority Data
Jun. 30, 2021 (JP) 2021-109362

(51) Int. Cl. H05B 3/84; H05B 3/64

(52) U.S. Cl. CPC H05B 3/84; H05B 3/64; H05B 2203/003; H05B 2203/016; H05B 2203/025

(57) ABSTRACT

Provided is a vehicular glass module capable of suppressing the concentration of thermal stress at a side of the glass panel. A vehicular glass module includes: a glass panel having an information acquisition area facing an information acquisition device and transmitting light; and a heater unit configured to heat at least a part of the information acquisition area of the glass panel. The information acquisition area is disposed close to a side of the glass panel. The heater unit includes: a power feeder disposed between the side of the glass panel and the information acquisition area; a heater disposed in the information acquisition area along a plate surface of the glass panel, the heater receiving power supply from the power feeder to generate heat; and a conductive wire connecting the power feeder and the heater. The conductive wire has an intermediate heater unit that heats between the upper side of the glass panel and the information acquisition area.

### TECHNICAL FIELD

The present invention relates to a vehicular glass module.

### BACKGROUND ART

A vehicle in areas with low temperatures, for example, may cause the windshield (the vehicular glass module that is the front windshield) to fog or in some cases freeze due to a temperature difference between inside and outside the vehicle, which may interfere with the driving. Various methods have been proposed for removing these fog and/or ice from windshields. Patent Literature 1, for example, proposes a busbar and a heating wire placed inside a glass panel of the windshield, and thus removing fogging by the heat generated at these busbar and heating wire. A vehicle with an information acquisition device attached on the windshield has been known, and this windshield has a heater in the information acquisition area where the information acquisition device acquires information, thus preventing fogging and freezing.

### CITATION LIST

### Patent Literature

Patent Literature 1: JP 2017-216193 A

### SUMMARY OF INVENTION

### Technical Problem

The windshield may have a temperature difference generated between the information acquisition area and the side close to this information acquisition area in the glass panel when the information acquisition area is heated with the heater. While thermal expansion occurs in the information acquisition area, the side close to the information acquisition area is not heated and does not undergo thermal expansion, so that thermal stress is concentrated to the side. The glass panel therefore may break at the side where the thermal stress is concentrated.

Thus, a vehicular glass module capable of suppressing the concentration of thermal stress at the side of the glass panel has been desired.

### Solution to Problem

A vehicular glass module according to a characterizing feature of the present invention supports an information acquisition device inside a vehicle, the information acquisition device being capable of receiving light from outside the vehicle. The vehicular glass module includes: a glass panel having an information acquisition area facing the information acquisition device and transmitting the light; and a heater unit configured to heat at least a part of the information acquisition area of the glass panel, the information acquisition area being disposed close to a side of the glass panel, the heater unit including: a power feeder disposed between the side of the glass panel and the information acquisition area; a heater disposed in the information acquisition area along a plate surface of the glass panel, the heater receiving power supply from the power feeder to generate heat; and a conductive wire connecting the power feeder and the heater, the conductive wire having an intermediate heater unit that heats between the side of the glass panel and the information acquisition area.

The glass panel of the vehicular glass module is configured to heat the information acquisition area, which causes a temperature difference between the information acquisition area and the sides that are not heated. If the temperature difference between the information acquisition area and the sides is large in the glass panel, thermal stress concentrates at the sides because the information acquisition area expands thermally while the sides do not. Thus, the conductive wire in this characterizing feature has the intermediate heater unit that heats between a side and the information acquisition area of the glass panel, in addition to the heater that heats the information acquisition area. This allows the intermediate heater unit to heat the intermediate area between the side of the glass panel and the information acquisition area. Heating the intermediate area allows the glass panel to have a gentle temperature gradient from the information acquisition area to the side, which prevents the local concentration of large thermal stress at the side of the glass panel. Especially, the intermediate heater unit is placed close to the side, thus making the temperature gradient gentle also along the side, and dispersing the thermal stress applied to the side. As a result, this configuration solves the problem of glass-panel breaking due to thermal cracking at the side where thermal stress is concentrated. In this way, this characterizing feature provides a vehicular glass module capable of suppressing the concentration of thermal stress at the side of the glass panel.

Another characterizing feature resides in that the information acquisition area is disposed close to an upper side of the glass panel.

This characterizing feature has the information acquisition area positioned close to the upper side of the glass panel, so that when a driver drives the vehicle having the windshield that is the vehicular glass module, the information acquisition area is less likely to obstruct the driver's view. This keeps good driver's visibility with the windshield. When an information acquisition device such as a camera is placed facing the information acquisition area, the parts in front such as the hood are less likely to become a blind spot for the information acquisition device. This easily keeps good field of view for the information acquisition device.

Another characterizing feature resides in that the intermediate heater unit generates an amount of heat per unit area that is smaller than an amount of heat the heater generates per unit area.

This characterizing feature keeps the amount of heat generated at the intermediate heater unit, which heats between the side and the information acquisition area, smaller than that generated at the heater, which heats the information acquisition area. This allows the intermediate heater unit to be at a lower temperature than at the information acquisition area. As a result, the temperature of the glass panel decreases gradually from the information acquisition area to the side, thus reducing the thermal stress generated at the side of the glass panel.

Another characterizing feature resides in that the intermediate heater unit extends in a same direction as the side of the glass panel extends.

The intermediate heater unit in this characterizing feature extends in the same direction as the side of the glass panel, meaning that the intermediate heater unit expands in the width direction of the information acquisition area. This makes a temperature gradient in the glass panel gentle over a wide area from the information acquisition area to the side. This decreases the thermal stress generated at the side of the glass panel over a wide area.

Another characterizing feature resides in that the intermediate heater unit has an end in a direction along the side of the glass panel, the end being folded back to have a plurality of wire sections of the conductive wire along the side, the plurality of wire sections being spaced apart in a direction perpendicular to the side.

This characterizing feature extends the intermediate heater unit in the plane direction perpendicular to the side of the glass panel. This makes a temperature gradient in the glass panel gentle over a wide area from the information acquisition area to the side. This decreases the thermal stress generated at the side of the glass panel over a wide area.

Another characterizing feature resides in that the intermediate heater unit has a maximum width in a direction along the side of the glass panel, the maximum width being smaller than a maximum width of the heater in the direction.

The heater that heats the information acquisition area has a concentric heating range around it.

The side and the information acquisition area are close to each other. This means that, even if the maximum width of the intermediate heater unit is smaller than the maximum width of the heater, the intermediate heater unit makes the thermal stress at the side uniform. Reducing the maximum width of the intermediate heater unit also saves the power consumption.

Another characterizing feature resides in that the intermediate heater unit has a plurality of wire sections of the conductive wire along the side, and the wire sections has widths along the side that gradually decrease with increasing proximity to the side.

If the distance between the side and the information acquisition area is relatively large in the glass panel, heating the information acquisition area may cause the concentration of thermal stress on a narrow area at the side. This concentration of thermal stress on the side has to be eliminated. To this end, the widths of the wire sections in the intermediate heater unit preferably gradually reduce so as to heat the side over a wide range. When the distance between the side and the information acquisition area is relatively small, heating the information acquisition area generates uniform thermal stress over a wide area at the side. In this case, the width of the intermediate heater unit preferably is large to heat the wide area at the side. Thus, the widths of the wire sections of the intermediate heater unit to be heated decrease gradually toward the side as in this characterizing feature, thus properly heating the side according to the distance between the information acquisition area and the side, and making the temperature gradient gentle between the information acquisition area and the side. This prevents the concentration of thermal stress generated on the side of the glass panel.

Another characterizing feature resides in that the glass panel includes a first glass plate facing the exterior of the vehicle and a second glass plate facing the interior of the vehicle, the first and second glass plates being opposed to each other, the glass panel as a whole being curved in a convex shape toward the exterior of the vehicle, the first glass plate having a first surface facing the exterior of the vehicle and a second surface on the back of the first surface, the second glass plate having a third surface opposed to the second surface and a fourth surface on the back of the third surface, the heater that heats the information acquisition area being disposed on the second or fourth surface, the side of the first surface receives a maximum thermal stress in response to energization of the heater, the maximum thermal stress being smaller than thermal stress generated in the information acquisition area of the first surface.

In this characterizing feature, the glass panel of the vehicular glass module may include a laminated glass. In this case, the heater that heats the information acquisition area to prevent fogging or freezing will be placed on the second surface or the fourth surface of the glass panel. Then, thermal expansion occurs on the second surface or the fourth surface, and the first surface is curved in a convex shape and is pushed outward from the vehicle. This generates thermal stress also at the information acquisition area and at the side close to the information acquisition area in the first surface. The side of the glass panel is a portion formed by cutting out a large-sized glass plate. The side therefore may have scratches and others that occur during cutting of the large-sized glass plate. The side therefore has lower breaking strength than the plane portion of the glass panel. This characterizing feature therefore has the maximum thermal stress generated at the side that is smaller than the thermal stress generated in the information acquisition area on the first surface of the glass panel. This prevents breakage of the glass panel due to thermal stress.

Another characterizing feature resides in that the heater is disposed away from an end of the information acquisition area close to the side by one-fifth or more of a dimension of the information acquisition area in the direction perpendicular to the side.

The heater in this characterizing feature is placed at a distance of a predetermined length or longer from the end of the information acquisition area close to the side, so that the glass panel heated by the intermediate heater unit and heater has a temperature that rises gradually from the side to the information acquisition area. This decreases the thermal stress generated at the side of the glass panel, and prevents breakage of the glass panel at the side.

Another characterizing feature resides in that the intermediate heater unit is disposed away from the side by one-fifth or more of a distance between the side and the information acquisition area in the direction perpendicular to the side.

The intermediate heater unit in this characterizing feature is placed at a distance of a predetermined length or longer from the position that is the closest to the side, so that the glass panel heated by the intermediate heater unit has a temperature that rises gradually from the side to the information acquisition area. This decreases the thermal stress generated at the side of the glass panel, and prevents breakage of the glass panel at the side.

Another characterizing feature resides in that the heater includes a heating wire.

The heater in this characterizing feature includes a heating wire, which allows the heating wire to be freely placed according to the shape of the information acquisition area. This increases the degree of freedom in placing the heater in order to efficiently heat the information acquisition area.

Another characterizing feature resides in that the heating wire includes a plurality of first heating wire sections extending in parallel within the information acquisition area; and a second heating wire section that connects the plurality of first heating wire sections outside of the information acquisition area, wherein the second heating wire section has a thickness that is larger than a thickness of the first heating wire sections.

The heating wire of the heater in this characterizing feature includes a plurality of first heating wire sections that are placed within the information acquisition area to extend parallel. This configuration properly distributes the first heating wire sections in the information acquisition area. The thickness of the second heating wire section, which connects the plurality of first heating wire sections, is larger than that of the first heating wire sections. This configuration makes the resistance of the second heating wire section smaller than that of the first heating wire sections when the entire heating wire is made of the same conductive material. This suppresses the amount of heat generated in the second heating wire section to be less than that of the first heating wire sections. This makes the temperature gradient of the glass panel gentle from the information acquisition area to the surrounding area, thus preventing the problem of thermal stress concentration at the side.

Another characterizing feature resides in that the heater is trapezoidal in overall shape, the width along the side of which decreases with increasing proximity to the side.

The width heated by the heater in this characterizing feature decreases gradually toward the side, thus enabling a gentle temperature gradient from the information acquisition area to the side. This keeps the thermal stress generated at the side of the glass panel small.

Another characterizing feature resides in that the heater includes: a transparent conductive film covering the information acquisition area; and a pair of busbars that are disposed outside the information acquisition area and are disposed facing each other so as to supply power to the transparent conductive film.

The heater that heats the information acquisition area in this characterizing feature includes a transparent conductive film and a busbar, which allows the information acquisition area to be heated evenly and improves the visibility of the information acquisition area.

Another characterizing feature resides in that the transparent conductive film is trapezoidal in overall shape, the width along the side of which decreases with increasing the proximity to the side, wherein the pair of busbars include: a first busbar disposed close to the side; and a second busbar disposed on the opposite side of the first busbar relative to the transparent conductive film, the second busbar being divided in the direction along the side.

The first busbar and the second busbar in this characterizing feature are placed at opposite positions across the transparent conductive film, and the second busbar is divided in the direction of the side. This allows current between the second busbar and the first busbar to flow through the shortest distance, which enables efficient heating of the information acquisition area.

### BRIEF DESCRIPTION OF DRAWINGS

FIG. 1 is a plan view of a first embodiment of a vehicular glass module.

FIG. 2 is a partial side cross-sectional view of the first embodiment of the vehicular glass module.

FIG. 3 is a schematic diagram of the main part of the first embodiment of the vehicular glass module.

FIG. 4 is a schematic diagram of the main part of a vehicular glass module that is a comparative example.

FIG. 5 is a partial side cross-sectional view of modification example 1 of the first embodiment.

FIG. 6 is a schematic diagram of the main part of the second embodiment of the vehicular glass module.

FIG. 7 is a schematic diagram of the main part of modification example 1 of the second embodiment.

FIG. 8 is a schematic diagram of the main part of modification example 2 of the second embodiment.

FIG. 9 is a schematic diagram of the main part of the third embodiment of the vehicular glass module.

FIG. 10 is a schematic diagram of the main part of the fourth embodiment of the vehicular glass module.

FIG. 11 is a schematic diagram of the main part of the fifth embodiment of the vehicular glass module.

### DESCRIPTION OF EMBODIMENTS

Referring to the drawings, the following describes some embodiments of a vehicular glass module according to the present invention. The present invention is not limited to the embodiments described below, and may be modified variously without deviating from the scope of the invention.

### First Embodiment

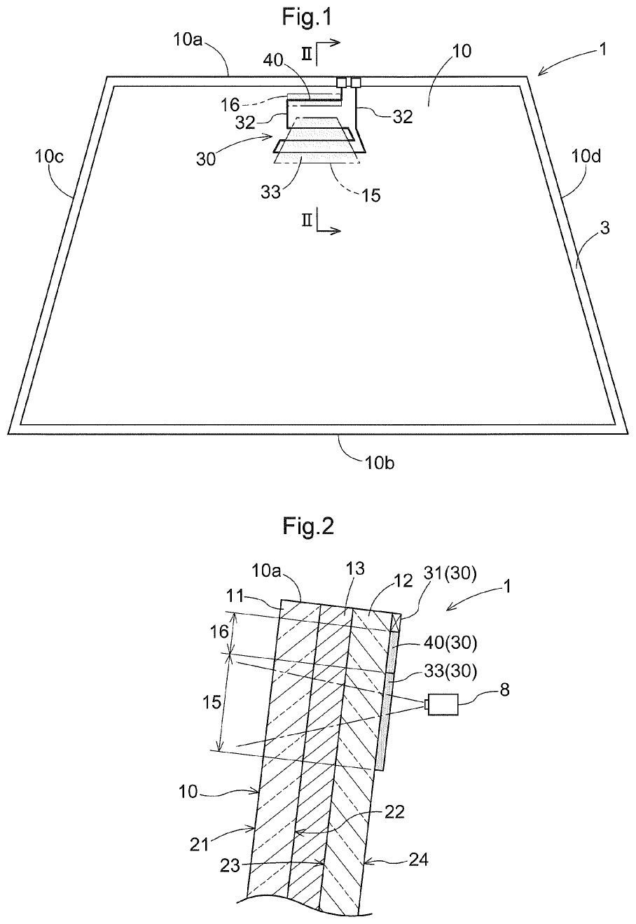

As shown in FIG. 1, a vehicular glass module 1 (hereinafter referred to as “glass module 1”) according to the present embodiment includes a glass panel 10 and a heater unit 30. As shown in FIG. 2, the glass panel 10 includes a first glass plate 11 facing the exterior of the vehicle and a second glass plate 12 facing the interior of the vehicle where the first and second glass plates 11, 12 are opposed to each other. The glass panel 10 is a laminated glass having the first glass plate 11 and second glass plate 12 that are bonded together via an intermediate layer 13. The intermediate layer 13 includes an adhesive layer, and the adhesive layer includes an area generating heat from a conductive wire 32 and a heater 33, which will be described later. The heater unit 30 heats an information acquisition area 15, which will be described later, located in the glass panel 10.

The first glass plate 11 constituting the glass panel 10 has a first surface 21 facing the exterior of the vehicle and a second surface 22 on the back of the first surface 21, and the second glass plate 12 has a third surface 23 opposed to the second surface 22 and a fourth surface 24 on the back of the third surface 23. The first glass plate 11 and second glass plate 12 have substantially the same shape and have a trapezoidal shape in plan view. The glass panel 10 has an upper side 10a, a lower side 10b, a left side 10c, and a right side 10d viewed from inside the vehicle, and the upper side 10a is shorter than the lower side 10b (see FIG. 1). The glass panel 10 may have the first and second glass plates 11 and 12 that are rectangular.

The glass plates 11 and 12 may be well-known glass plates. Examples of the glass plates 11 and 12 include heat-absorbing glass, clear glass, green glass, and UV green glass. Note that the glass plates 11 and 12 are configured to achieve visible light transmittance that complies with the safety standards of the country in which the vehicle is used.

The glass panel 10 has a shielding layer 3 along the peripheral edge to shield the view from outside the vehicle. As shown in FIG. 1, the shielding layer 3 in this embodiment has an annular shape. The vehicle, to which the glass panel 10 is attached, has an imaging device 8 (an example of an information acquisition device) attached to the interior of the vehicle via a bracket (not shown), for example, and the imaging device is capable of receiving light from outside the vehicle. The imaging device 8 is placed so that a substantially central area near the upper side 10a (an example of sides) of the glass panel 10 falls within its angle of view. The glass panel 10 has a light-transmitting information acquisition area 15 that faces the imaging device 8. The information acquisition area 15 is positioned close to the upper side 10a of the glass panel 10. Specifically, the information acquisition area 15 is located below the approximately central area of the upper side 10a. Thus, the imaging device 8 is positioned closer to the interior of the vehicle than the glass panel 10, and captures images of the exterior of the vehicle through the information acquisition area 15.

The present embodiment has the information acquisition area 15 positioned close to the upper side 10a of the glass panel 10, so that when a driver drives the vehicle having the windshield that is the glass module 1, the information acquisition area 15 is less likely to obstruct the driver's view. This keeps good driver's visibility with the glass panel 10. When an information acquisition device such as a camera (imaging device 8) is placed facing the information acquisition area 15, the parts in front such as the hood are less likely to become a blind spot for the information acquisition device. This easily keeps good field of view for the information acquisition device.

The planar dimensions of the information acquisition area 15 are appropriately set for the imaging device 8 to be placed inside the vehicle. The information acquisition area 15 is just an area, through which the light emitted and/or received by the imaging device 8 passes. Thus, the planar dimensions of the information acquisition area 15 are set small relative to the planar dimensions of the glass panel 10, regardless of the type of imaging device 8. Note that, if the planar dimensions of the information acquisition area 15 are too small, high mounting accuracy of the imaging device 8 will be required. This also increases the effect of the distortion of the glass panel 10 that appears in the image acquired by the imaging device 8. If the planar dimensions of the information acquisition area 15 are too large, the driver's field of view will become narrow. This also widens the area heated by the heater 33, thus increasing the energy consumption of the vehicle. From this perspective, it is preferable that the planar dimensions of the information acquisition area 15 be set in the range of 20 mm (length)×20 mm (width) to 250 mm (length)×500 mm (width), and more preferable that they be set in the range of 50 mm (length)×50 mm (width) to 150 mm (length)×400 mm (width).

The heater unit 30 heats at least a part of the information acquisition area 15 of the glass panel 10 to remove fogging and/or ice from the information acquisition area 15. As shown in FIG. 2, the heater unit 30 in this embodiment is located adjacent to the fourth surface 24 of the second glass plate 12 (glass panel 10). The intermediate layer 13 is sandwiched between the first and second glass plates 11, 12 to join both glass plates 11 and 12. This intermediate layer 13 has a three-layered structure, including a soft core layer sandwiched between a pair of outer layers. The pair of outer layers is harder than the soft core layer. This multi-layered intermediate layer 13 with the soft and hard layers enhances the breakage resistance and sound insulation performance of the glass material. The intermediate layer 13 may include a plurality of layers having different hardness as described above. In this case, polyvinyl butyral resin (PVB) can be used for the hard outer layers. This polyvinyl butyral resin (PVB) is favorable as a material for the outer layers because it has excellent adhesiveness and penetration resistance. The soft core layer can be made of ethylene vinyl acetate resin (EVA) or a polyvinyl acetal resin that is softer than the polyvinyl butyral resin used for the outer layers.

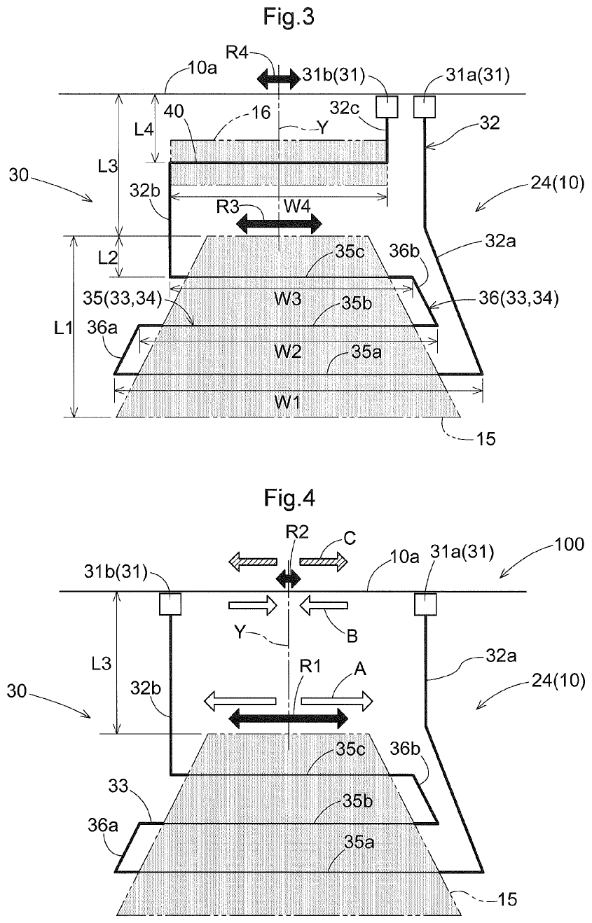

Referring to FIG. 3, the following describes the heater unit 30 in detail. The heater unit 30 includes a power feeder 31, a heater 33, and a conductive wire 32 that connects the power feeder 31 and the heater 33. The power feeder 31 includes a pair of power feeders 31a and 31b. These power feeders 31a and 31b are placed side by side in the extending direction of the upper side 10a, that is, to the left and right. FIG. 3 omits the shielding layer 3. The power feeders 31a and 31b are placed close to the upper side 10a of the glass panel 10, and this configuration facilitates wiring to the power feeders 31a and 31b. The wiring to the power feeders 31a and 31b in the glass module 1 does not interfere with the view of the vehicle occupants.

The pair of power feeders 31a and 31b are connected in series with the heater 33. The conductive wire 32 includes: a first conductive wire 32a between the power feeder 31a and the heater 33; a second conductive wire 32b between the heater 33 and an intermediate heater unit 40 (described later); and a third conductive wire 32c between the intermediate heater unit 40 and the power feeder 31b. The heater 33 is located along the plate surface of the glass panel 10 in the information acquisition area 15 and receives power supply from the power feeder 31 to generate heat. This allows the information acquisition area 15 to receive the heat from the heater 33 and remove ice and others.

As shown in FIG. 3, the heater 33 includes a heating wire 34. The heating wire 34 (heater 33) is folded back at a plurality of positions at intervals and is prepared to pass through the information acquisition area 15 and its surroundings. In one example, the heating wire 34 in this embodiment is shaped including: a plurality of first heating wire sections 35 extending in parallel within the information acquisition area 15; and second heating wire sections 36 connecting the plurality of first heating wire sections 35 outside the information acquisition area 15. In this embodiment, the plurality of first heating wire sections 35 are placed to be parallel to the upper side 10a of the glass panel 10. The thickness of the second heating wire sections 36 is larger than that of the first heating wire sections 35. The first heating wire sections 35 include three horizontal wire sections 35a, 35b, and 35c that extend linearly to the left and right within the information acquisition area 15. The first horizontal wire section 35a connects to the first conductive wire 32a led out from the power feeder 31a, and the second horizontal wire section 35b and third horizontal wire section 35c are placed in this order toward the upper side 10a. The second heating wire sections 36 includes: a first vertical wire section 36a placed between the first horizontal wire section 35a and second horizontal wire section 35b; and a second vertical wire section 36b placed between the second horizontal wire section 35b and third horizontal wire section 35c. The heating wire 34 of the heater 33 also includes a portion of the first conductive wire 32a extending along the first horizontal wire section 35a and a portion of the second conductive wire 32b extending along the third horizontal wire section 35c.

The conductive wire 32 has the intermediate heater unit 40, and this intermediate heater unit 40 heats between the upper side 10a of the glass panel 10 and the information acquisition area 15. The intermediate heater unit 40 includes a portion of the conductive wire 32. In this embodiment, the second conductive wire 32b led out from the heater 33 extends toward the upper side 10a, and the intermediate heater unit 40 continuous to the second conductive wire 32b extends in the same direction as the upper side 10a of the glass panel 10. In this embodiment, the conductive wire 32 has the first conductive wire 32a, the second conductive wire 32b, the intermediate heater unit 40, and the third conductive wire 32c, all of which have the same thickness. The conductive wire 32 and the second heating wire 36 also have the same thickness. The conducting wire 32 may be configured so that the intermediate heater unit 40 may be different in thickness from the conductive wires 32a, 32b, and 32c, and the intermediate heater unit 40 may be different in thickness from the second heating wire 36.

FIG. 4 shows a glass module 100 that is a comparative example. The glass module 100 in FIG. 4 that is comparative example has a heater 33 that heats the information acquisition area 15 of the glass panel 10 and does not have an intermediate heater unit 40. Specifically, the pair of power feeders 31a and 31b are spaced apart along the upper side 10a. The conductive wire 32a led out from the power feeder 31a is placed vertically, and connects to the first horizontal wire section 35a at the bottom of the heater 33. The heater 33 includes the first horizontal wire section 35a, the second horizontal wire section 35b, the first vertical wire section 36a, and the second vertical wire section 36b that are placed within the information acquisition area 15. The second conductive wire 32b is led out from the upper horizontal wire section 35c in the information acquisition area 15, and is linearly placed vertically to connect to the power feeder 31b.

In this glass module 100 in FIG. 4 that is comparative example, heating the information acquisition area 15 with the heater 33 generates a temperature difference in the glass panel 10 between the information acquisition area 15 and the upper side 10a close to the information acquisition area 15. If the glass panel 10 freezes in winter, for example, then the information acquisition area 15 is heated by the heater 33. This allows the glass panel 10 to remove the freezing in the information acquisition area 15, thus enabling proper use of the information acquisition area 15. However, the upper side 10a close to the information acquisition area 15 is not heated by the heater 33, so that the temperature does not rise there and remains low. In this case, thermal expansion occurs in the direction of arrow A in the information acquisition area 15, and tensile stress as thermal stress acts mainly in area R1, for example, in the portion adjacent to the information acquisition area 15. The area R1 is approximately equally present to the left and right from the reference line Y that bisects the information acquisition area 15 into left and right halves at the top of the glass panel 10. The upper side 10a adjacent to the information acquisition area 15 receives both compressive stress, which constrains thermal expansion in the direction opposite to arrow A (direction of arrow B), and tensile stress (force of arrow C) as thermal stress. As a result, tensile stress concentrates on a narrow area R2 close to the reference line Y at the upper side 10a. This tensile stress is proportional to the temperature difference between the information acquisition area 15 heated by the heater 33 and the upper side 10a that is not heated by the heater 33. Therefore, if a tensile stress exceeding the edge strength of the glass panel 10 occurs, the glass panel 10 will crack due to heat (this may be called thermal cracking).

As shown in FIGS. 1 and 3, the conductive wire 32 of this embodiment includes the intermediate heater unit 40 that heats between the upper side 10a and the information acquisition area 15 of the glass panel 10, in addition to the heater 33 that heats the information acquisition area 15. This allows the intermediate heater unit 40 of the conductive wire 32 to heat the intermediate area 16 between the upper side 10a of the glass panel 10 and the information acquisition area 15. Heating the intermediate area 16 allows the glass panel 10 to have a gentle temperature gradient from the information acquisition area 15 to the upper side 10a. This prevents the local concentration of large thermal stress at the upper side 10a of the glass panel 10. Especially, the intermediate heater unit 40 is placed close to the upper side 10a, thus making the temperature gradient gentle also along the upper side 10a, and dispersing the thermal stress applied to the upper side 10a. This means that, as shown in FIG. 3, tensile stress as thermal stress mainly acts at the upper side 10a in area R4 that is wider to the left and right from the reference line Y than the area R2 in FIG. 4. As a result, this embodiment solves the problem that the glass panel 10 is damaged due to thermal cracking at the upper side 10a located near the information acquisition area 15. The intermediate heater unit 40 in this embodiment heats around the information acquisition area 15, so that the area adjacent to the information acquisition area 15 will receive tensile stress as thermal stress acting mainly in area R3, which is narrower to the left and right from the reference line Y than the area RI shown in FIG. 4.

The intermediate heater unit 40 extends in the same direction as the upper side 10a of the glass panel 10, meaning that the intermediate heater unit 40 expands in the width direction of the information acquisition area 15. This makes a temperature gradient in the glass panel 10 gentle over a wide area from the information acquisition area 15 to the upper side 10a. This decreases the thermal stress generated at the upper side 10a of the glass panel 10 over a wide area.

The heating wire 34 of the heater 33 includes a plurality of first heating wire sections 35 (35a, 35b, 35c) that are placed within the information acquisition area 15 to extend parallel along the upper side 10a. This configuration properly distributes the first heating wire sections 35 in the information acquisition area 15. The thickness of the second heating wire sections 36 is larger than that of the first heating wire sections 35. This configuration makes the resistance of the second heating wire sections 36 smaller than that of the first heating wire sections 35 when the entire heating wire 34 is made of the same conductive material. This allows the amount of heat generated by the second heating wire sections 36 to be less than that of the first heating wire sections 35, resulting in a gentle temperature gradient of the glass panel 10 from the information acquisition area 15 to its surroundings. This prevents the problem of thermal stress concentrating on the upper side 10a of the glass panel 10.

This embodiment is configured so that the amount of heat generated per unit area of the intermediate heater unit 40 is smaller than the amount of heat generated per unit area of the heater 33. This allows the intermediate heater unit 40 to be at a lower temperature than at the information acquisition area 15. As a result, the temperature of the glass panel 10 decreases gradually from the information acquisition area 15 to the upper side 10a, thus reducing the thermal stress generated at the upper side 10a of the glass panel 10.

The heating wire 34 of the heater 33 has a width WI mainly at the first horizontal wire section 35a, a width W2 mainly at the second horizontal wire section 35b, and a width W3 mainly at the third horizontal wire section 35c in the direction along the upper side 10a of the glass panel 10, where these widths decrease in the order of W1 to W3. The intermediate heater unit 40 has a maximum width W4 in the direction along the upper side 10a, where the width W4 is smaller than the maximum width W1 of the heater 33.

The upper side 10a of the first surface 21 generates a maximum thermal stress when the heater 33 is energized, and this maximum thermal stress is smaller than the thermal stress generated in the information acquisition area 15 of the first surface 21.

The heater 33 is placed away from the end of the information acquisition area 15 close to the upper side 10a by at least one-fifth of the dimension L1 of the information acquisition area 15 in the direction perpendicular to the upper side 10a. That is, as shown in FIG. 3, the distance L2 is one-fifth or more of the dimension L1. The heater 33 is placed at a distance of a predetermined length or longer from the end of the information acquisition area 15 close to the upper side 10a, so that the glass panel 10 heated by the intermediate heater unit 40 and heater 33 has a temperature that rises gradually from the upper side 10a to the information acquisition area 15.

The intermediate heater unit 40 is placed away from the upper side 10a of the glass panel 10 by at least one-fifth of the distance L3 between the upper side 10a and the information acquisition area 15 in the direction perpendicular to the upper side 10a. That is, as shown in FIG. 3, the distance L4 is one-fifth or more of the distance L3. The intermediate heater unit 40 in this embodiment is placed at a distance of a predetermined length or longer from the upper side 10a toward the information acquisition area 15. Thus, the glass panel 10 heated by the intermediate heater unit 40 has a temperature that rises gradually from the upper side 10a toward the information acquisition area 15.

The heater 33 is trapezoidal in overall shape, with the width along the upper side 10a decreasing with increasing the proximity to the upper side 10a. That is, as shown in FIG. 3, the width W1 of the first horizontal wire section 35a, the width W2 of the second horizontal wire section 35b, and the width W3 of the third horizontal wire section 35c decrease in this order. The widths heated by the heater 33 decrease gradually toward the upper side 10a, thus enabling a gentle temperature gradient from the information acquisition area 15 to the upper side 10a.

### Modification Example 1 of First Embodiment

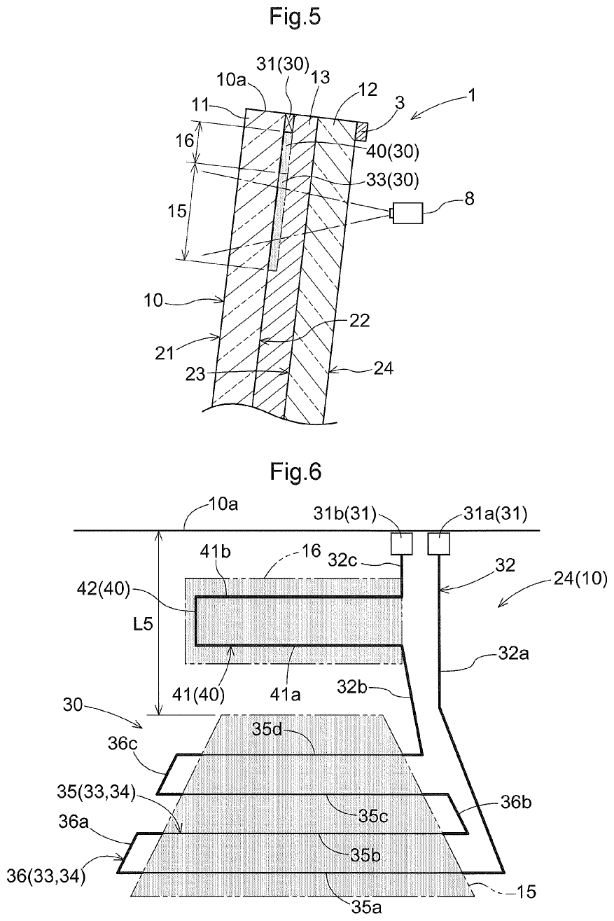

FIG. 5 shows Modification example 1. The heater unit 30 may be located adjacent to the second surface 22 of the first glass plate 11 (glass panel 10). In this case, the power feeders 31a and 31b of the heater unit 30 are placed inside the notch (not shown) at the upper side 10a of the second glass plate 12 in the plane so as not to be exposed from the notch. The power feeders 31a and 31b are placed within the shielding layer 3 (see FIG. 1) in the viewing direction from inside the vehicle. Instead of the power feeders 31a and 31b, the heater 33 of the heater unit 30 may be connected to a harness. The harness has one end connected to the heater 33, and the other end led out to the outside of the glass panel 10 via between the intermediate layer 13 and the second glass plate 12. The other configuration is the same as the first embodiment.

### Modification Example 2 of First Embodiment

The entire glass panel 10 may be curved in a convex shape toward the outside of the vehicle. This modified example 2 is configured so that the maximum thermal stress generated at the upper side 10a is smaller than the thermal stress generated at the information acquisition area 15 on the first surface 21 of the glass panel 10. The other configuration is the same as the first embodiment.

The glass panel 10 of the glass module 1 includes a laminated glass of the first and second glass plates 11 and 12. In this case, the heater 33 that heats the information acquisition area 15 to prevent fogging or freezing will be placed on the second surface 22 or the fourth surface 24 of the glass panel 10. Then, thermal expansion occurs on the second surface 22 or the fourth surface 24, and the first surface 21, which is curved in a convex shape, is pushed outward of the vehicle. This generates thermal stress also at the information acquisition area 15 and at the upper side 10a close to the acquisition area 15 in the first surface 21. The upper side 10a of the glass panel 10 is a portion formed by cutting out a large-sized glass plate. The upper side 10a therefore may have scratches and others that occur during cutting of the large-sized glass plate. The upper side 10a therefore has lower breaking strength than the plane portion of the glass panel 10. This modified example therefore is configured to have the maximum thermal stress generated at the upper side 10a that is smaller than the thermal stress generated in the information acquisition area 15 on the first surface 21 of the glass panel 10. This prevents breakage of the glass plates 11, 12 due to thermal stress.

### Second Embodiment

As shown in FIG. 6, the second embodiment is configured to have a distance L5 between the upper side 10a of the glass panel 10 and the information acquisition area 15 that is longer than the same distance L3 in the first embodiment. This embodiment has the intermediate heater unit 40 that has an end in the direction along the upper side 10a of the glass panel 10, the end being folded back so that a plurality of horizontal wire sections 41 along the upper side 10a are spaced apart in a direction perpendicular to the upper side 10a. Specifically, the intermediate heater unit 40 includes: a first horizontal wire section 41a that is continuous to the second conductive wire 32b and along the upper side 10a, and a second horizontal wire section 41b, the first and second horizontal wire sections 41a and 41b being placed in this order toward the upper side 10a; and a vertical wire section 42 between these first horizontal wire section 41a and second horizontal wire section 41b. The first horizontal wire section 41a is continuous with the second conductive wire 32b, and the second horizontal wire section 41b is continuous with the third conductive wire 32c.

The first heating wire sections 35 of the heater 33 include four horizontal wire sections 35a, 35b, 35c, and 35d that extend linearly to the left and right within the information acquisition area 15. The first horizontal wire section 35a connects to the first conductive wire 32a led out from the power feeder 31a, and the second horizontal wire section 35b, third horizontal wire section 35c and fourth horizontal wire section 35d are placed in this order toward the upper side 10a. The second heating wire sections 36 include: a first vertical wire section 36a placed between the first horizontal wire section 35a and second horizontal wire section 35b; a second vertical wire section 36b placed between the second horizontal wire section 35b and third horizontal wire section 35c; and a third vertical wire section 36c placed between the third horizontal wire section 35c and fourth horizontal wire section 35d. The heating wire 34 of the heater 33 also includes a portion of the first conductive wire 32a extending along the first horizontal wire section 35a and a portion of the second conductive wire 32b extending along the fourth horizontal wire section 35d.

The second embodiment extends the intermediate heater unit 40 in the plane direction perpendicular to the upper side 10a of the glass panel 10. This makes a temperature gradient in the glass panel 10 gentle over a wide area from the information acquisition area 15 to the upper side 10a. This decreases the thermal stress generated at the upper side 10a of the glass panel 10 over a wide area.

### Modification Example 1 of Second Embodiment

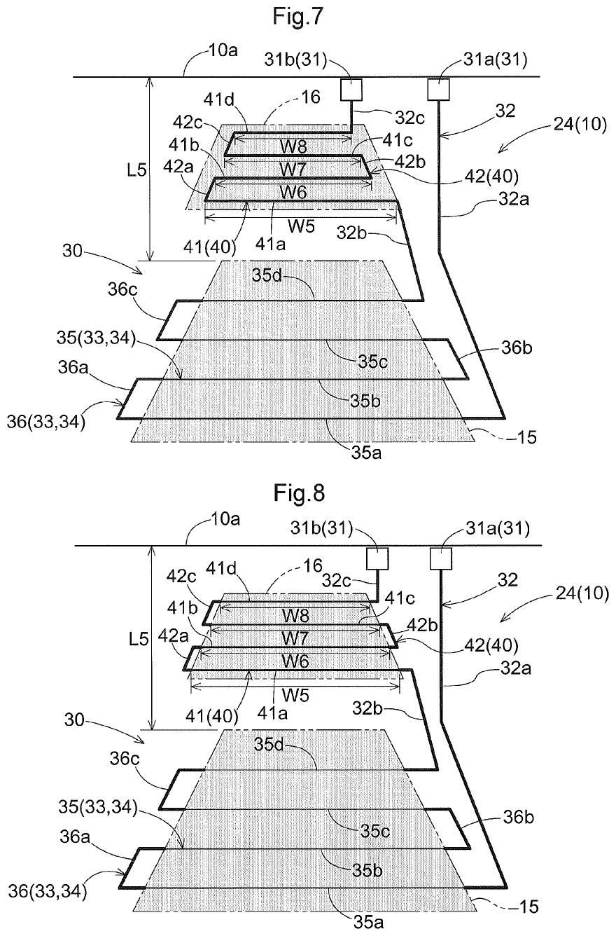

FIG. 7 shows modification example 1. The intermediate heater unit 40 in this example has a plurality of horizontal wire sections 41 along the upper side 10a, and these horizontal wire sections 41 are configured to have their widths along the upper side 10a that gradually decrease with increasing the proximity to the upper side 10a. Specifically, the intermediate heater unit 40 includes the horizontal wire sections 41 having a first horizontal wire section 41a, a second horizontal wire section 41b, a third horizontal wire section 41c, and a fourth horizontal wire section 41d that are along the upper side 10a and are placed in this order toward the upper side 10a. The intermediate heater unit 40 includes vertical wire section 42 having: a first vertical wire section 42a placed between the first horizontal wire section 41a and second horizontal wire section 41b; a second vertical wire section 42b placed between the second horizontal wire section 41b and third horizontal wire section 41c; and a third vertical wire section 42c placed between the third horizontal wire section 41c and fourth horizontal wire section 41d. These horizontal wire sections 41 are configured so that width W5 of the first horizontal wire section 41a, width W6 of the second horizontal wire section 41b, width W7 of the third horizontal wire section 41c, and width W8 of the fourth horizontal wire section 41d decrease gradually in this order.

If the distance L5 between the upper side 10a and the information acquisition area 15 is relatively large in the glass panel 10, heating the information acquisition area 15 may cause the concentration of thermal stress on a narrow area at the upper side 10a. This concentration of thermal stress on the upper side 10a has to be eliminated. To this end, the widths of the wire sections in the intermediate heater unit 40 preferably gradually reduce so as to heat the narrow region at the upper side 10a. When the distance between the upper side 10a and the information acquisition area 15 is relatively small, heating the information acquisition area 15 generates uniform thermal stress over a wide area at the upper side 10a. In this case, the width of the intermediate heater unit 40 preferably is large to heat the wide area at the upper side 10a. Thus, the widths of the wire sections of the intermediate heater unit 40 to be heated decrease gradually toward the upper side 10a as in this modified example 1, thus properly heating the upper side 10a according to the distance between the information acquisition area 15 and the upper side 10a, and making the temperature gradient gentle between the information acquisition area 15 and the upper side 10a. This prevents the concentration of thermal stress generated on the upper side 10a of the glass panel 10.

### Modification Example 2 Of Second Embodiment

FIG. 8 shows modification example 2. Similar to modification example 1, the intermediate heater unit 40 in this example has a plurality of horizontal wire sections 41 along the upper side 10a. These horizontal wire sections 41 are configured to have their widths along the upper side 10a that gradually decrease with increasing the proximity to the upper side 10a. The horizontal wire sections 41 in this example extend further left and right than in modification example 1, and the horizontal wire sections 41 have a thickness larger than that of the first heating wire sections 35 and smaller than that of vertical wire sections 42.

The intermediate heater unit 40 in this embodiment has the heating wire sections at both left and right ends that have a smaller amount of heat generated than at the central portion, which makes the temperature gradient gentle in the direction along the upper side 10a (side) of the glass panel 10. This reduces the concentration of thermal stress generated on the upper side 10a of the glass panel 10.

### Third Embodiment

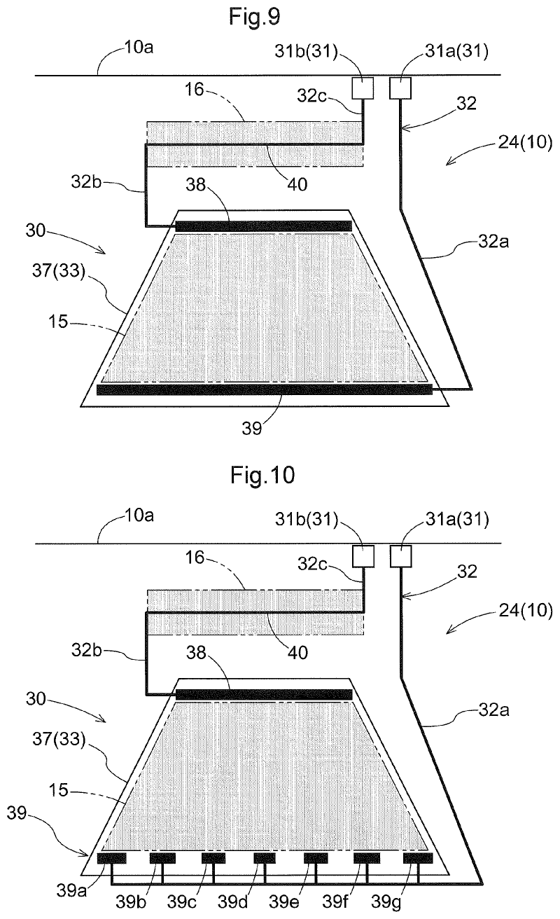

FIG. 9 shows a third embodiment. The heater 33 of the heater unit 30 in this embodiment includes a transparent conductive film 37 covering the information acquisition area 15, and a pair of busbars 38 and 39. The pair of busbars 38 and 39 are placed outside the information acquisition area 15 and are placed facing each other so as to supply power to the transparent conductive film 37. The pair of busbars 38 and 39 includes the first busbar 38 placed close to the upper side 10a, and the second busbar 39 placed on the opposite side of the first busbar 38 relative to the transparent conductive film 37. The transparent conductive film 37 is trapezoidal in overall shape, with the width along the upper side 10a decreasing with increasing the proximity to the upper side 10a. The other configuration is the same as the first embodiment.

The transparent conductive film 37 is stacked over the entire surface of the base film, and generates heat when voltage is applied to both the busbars 38 and 39. Examples of the material for the transparent conductive film 37 include, but not limited to, ITO, SnO₂ doped with Sb or F, zinc oxide doped with Al or Ga, TiO₂ doped with Nb, and transparent conductive oxide (TCO) such as tungsten oxide.

The heater 33 that heats the information acquisition area 15 includes the transparent conductive film 37 and the pair of busbars 38, 39 as in this embodiment, which allows the information acquisition area 15 to be heated evenly and improves the visibility of the information acquisition area 15.

### Fourth Embodiment

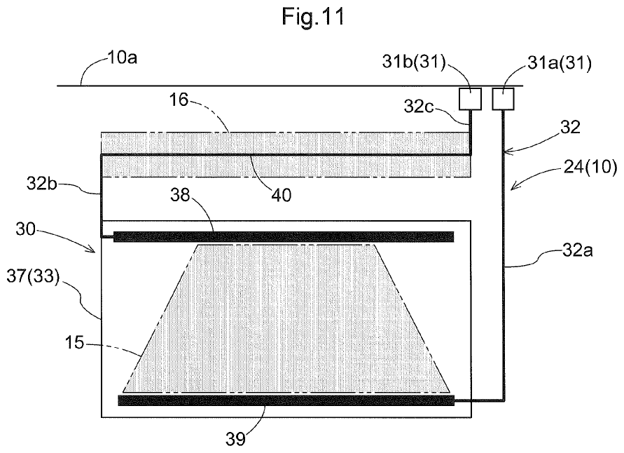

FIG. 10 shows a fourth embodiment. Similar to the third embodiment, the heater 33 includes a transparent conductive film 37 and a pair of busbars 38 and 39. The transparent conductive film 37 is trapezoidal in overall shape, with the width along the upper side 10a decreasing with increasing the proximity to the upper side 10a.

For the transparent conductive film 37 having a trapezoidal shape, the current is concentrated at the part of the second busbar 39 that is at the shortest distance from the first busbar 38. In this case, the trapezoidal transparent conductive film 37 has a high temperature at the upper part close to the first busbar 38, and thus the part has a large temperature difference from other parts. Thus, the fourth embodiment has the second busbar 39 of the pair of busbars 38 and 39, the second busbar 39 being divided in the direction along the upper side 10a. FIG. 10 shows an example where the second busbar 39 includes seven busbar sections 39a to 39g. This embodiment is configured so that the first busbar 38 and the second busbar 39 are placed at opposite positions across the transparent conductive film 37, and the second busbar 39 is divided in the direction of the side. The divided second busbar sections 39 (divided busbar sections 39a to 39g) are configured to decrease their horizontal width with increasing their proximity to the first busbar 38. That is, the divided busbar sections 39a to 39g are configured so that the horizontal width of busbar section 39d, which is located in the center in the horizontal direction, is the smallest, and the horizontal widths of busbar sections 39a-39c and 39e-39g gradually increase from the busbar section 39d toward both ends of the second busbar 39. This allows the voltage applied to each of the busbar sections 39a-39g of the second busbar 39 to be adjusted equal, thereby suppressing non-uniform heating over the transparent conductive film 37.

### Fifth Embodiment

The third and fourth embodiments show an example of the transparent conductive film 37 having the same trapezoidal shape as the information acquisition area 15. FIG. 11 shows a fifth embodiment. The transparent conductive film 37 is rectangular including the information acquisition area 15, and the busbars 38 and 39 as a pair have the same length. This embodiment includes the rectangular transparent conductive film 37 and the pair of busbars 38 and 39 of the same length. This keeps the distance between the pair of busbars 38 and 39 uniform. As a result, the information acquisition area 15 has a uniform potential gradient, so that the heater 33 uniformly generates heat over the information acquisition area 15. FIG. 11 shows an example of placing the pair of busbars 38 and 39 above and below the transparent conductive film 37, and the pair of busbars 38 and 39 may be placed on the left and right of the transparent conductive film 37.

### Other Embodiments

(1) The above embodiments show an example of the glass module 1 that is used for a front windshield of a vehicle. The glass module 1 may be used for a rear window or a side window of a vehicle.
(2) The above embodiments show an example of the information acquisition area 15 of the glass module 1, the information acquisition area 15 being positioned close to the upper side 10a of the glass panel 10. The information acquisition area 15 of the glass module 1 may be at a position other than close to the upper side 10a of the glass panel 10 (e.g., close to the lower side 10b, left side 10c, or right side 10d).
(3) The above embodiments show an example of the information acquisition area 15 and the heater 33 that are trapezoidal. The shape of the information acquisition area 15 and heater 33 is not limited to trapezoidal, which may be other shapes such as rectangular, circular, and oval.
(4) The above embodiments show an example of the intermediate heater unit 40 at a lower temperature than at the heater 33. The intermediate heater unit 40 may be configured to be at a higher temperature than at the heater 33.
(5) The above embodiments show an example of the intermediate heater unit 40 including a conductive wire. The intermediate heater unit 40 may include a transparent conductive film.
(6) The second to fifth embodiments show an example of the heater 33 heating the information acquisition area 15 and the intermediate heater unit 40 that are placed on the fourth surface 24 of the glass panel 10. Similar to modification example 1 of the first embodiment, the heater 33 and intermediate heater unit 40 may be placed on the second surface 22 of the glass panel 10.

### INDUSTRIAL APPLICABILITY

The present invention is widely applicable to vehicular glass modules with a heater unit that heats the information acquisition area.

### DESCRIPTION OF REFERENCE NUMERALS

1: vehicular glass module (glass module)
3: shielding layer
8: imaging device (information acquisition device)
10: glass panel
10a: upper side
11: first glass plate
12: second glass plate
13: intermediate layer
15: information acquisition area
16: intermediate area
21: first surface
22: second surface
23: third surface
24: fourth surface
30: heater unit
31: power feeder
32: conductive wire
33: heater
34: heating wire
35: first heating wire section
36: second heating wire section
37: transparent conductive film
38: first busbar
39: second busbar
40: intermediate heater unit
41: horizontal wire section
42: vertical wire section
L1: distance
L2: distance
L3: distance
L4: distance
L5: distance
W1: maximum width of information acquisition area
W4: maximum width of intermediate heater unit
Y: reference line

1. A vehicular glass module that supports an information acquisition device inside a vehicle, the information acquisition device being capable of receiving light from outside the vehicle, comprising:
a glass panel having an information acquisition area facing the information acquisition device and transmitting the light; and
a heater unit configured to heat at least a part of the information acquisition area of the glass panel,
the information acquisition area being disposed close to a side of the glass panel,
the heater unit including: a power feeder disposed between the side of the glass panel and the information acquisition area; a heater disposed in the information acquisition area along a plate surface of the glass panel, the heater receiving power supply from the power feeder to generate heat; and a conductive wire connecting the power feeder and the heater,
the conductive wire having an intermediate heater unit that heats between the side of the glass panel and the information acquisition area.

2. The vehicular glass module according to claim 1, wherein the information acquisition area is disposed close to an upper side of the glass panel.

3. The vehicular glass module according to claim 1, wherein the intermediate heater unit generates an amount of heat per unit area that is smaller than an amount of heat generated per unit area of the heater.

4. The vehicular glass module according to claim 1, wherein the intermediate heater unit extends in a same direction as the side of the glass panel extends.

5. The vehicular glass module according to claim 4, wherein the intermediate heater unit has an end in a direction along the side of the glass panel, the end being folded back to have a plurality of wire sections of the conductive wire along the side, the plurality of wire sections being spaced apart in a direction perpendicular to the side.

6. The vehicular glass module according to claim 4, wherein the intermediate heater unit has a maximum width in a direction along the side of the glass panel, the maximum width being smaller than a maximum width of the heater in the direction.

7. The vehicular glass module according to claim 6, wherein the intermediate heater unit has a plurality of wire sections of the conductive wire along the side, and the wire sections have widths along the side that gradually decrease with increasing proximity to the side.

8. The vehicular glass module according to claim 1, wherein the glass panel includes a first glass plate facing the exterior of the vehicle and a second glass plate facing the interior of the vehicle, the first and second glass plates being opposed to each other, the glass panel as a whole being curved in a convex shape toward the exterior of the vehicle,
the first glass plate having a first surface facing the exterior of the vehicle and a second surface on the back of the first surface,
the second glass plate having a third surface opposed to the second surface and a fourth surface on the back of the third surface,
the heater that heats the information acquisition area being disposed on the second or fourth surface,
the side of the first surface receives a maximum thermal stress in response to energization of the heater, the maximum thermal stress being smaller than thermal stress generated in the information acquisition area of the first surface.

9. The vehicular glass module according to claim 1, wherein the heater is disposed away from an end of the information acquisition area close to the side by one-fifth or more of a dimension of the information acquisition area in the direction perpendicular to the side.

10. The vehicular glass module according to claim 1, wherein the intermediate heater unit is disposed away from the side by one-fifth or more of a distance between the side and the information acquisition area in the direction perpendicular to the side.

11. The vehicular glass module according to claim 1, wherein the heater includes a heating wire.

12. The vehicular glass module according to claim 11, wherein the heating wire includes:
a plurality of first heating wire sections extending in parallel within the information acquisition area; and
a second heating wire section that connects the plurality of first heating wire sections outside of the information acquisition area, wherein
the second heating wire section has a thickness that is larger than a thickness of the first heating wire sections.

13. The vehicular glass module according to claim 11, wherein the heater is trapezoidal in overall shape, the width along the side of which decreases with increasing proximity to the side.

14. The vehicular glass module according to claim 1, wherein the heater includes:
a transparent conductive film covering the information acquisition area; and
a pair of busbars that are disposed outside the information acquisition area and are disposed facing each other so as to supply power to the transparent conductive film.

15. The vehicular glass module according to claim 14, wherein the transparent conductive film is trapezoidal in overall shape, the width along the side of which decreases with increasing the proximity to the side, wherein
the pair of busbars includes:
a first busbar disposed close to the side; and
a second busbar disposed on the opposite side of the first busbar relative to the transparent conductive film,
the second busbar being divided in the direction along the side.
